(19) United States
(12) Patent Application Publication
(10) Pub. No.: US 2023/0139055 A1
(43) Pub. Date: May 4, 2023

(54) HYDRAULIC CYLINDER WITH A SIDE LOAD SENSOR RETENTION PIN

(71) Applicant: Caterpillar Inc., Peoria, IL (US)

(72) Inventors: Matthew S Marquette, Edelstein, IL (US); Nimesh Akalanka Jayakody, Springfield, IL (US); Thomas K. Yeung, Bolingbrook, IL (US); Kurt S. Goslovich, Naperville, IL (US); Troy A. Settles, Farmington, IL (US); Bruce A. Croisant, Chillicothe, IL (US)

(21) Appl. No.: 17/514,745

(22) Filed: Oct. 29, 2021

(51) Int. Cl. F15B 15/28; F15B 15/14

(52) U.S. Cl. CPC F15B 15/2892; F15B 15/1433

(57) ABSTRACT

A hydraulic cylinder may include a housing and a rod extending from a working end positioned outside the housing through a rod end of the housing to a piston end positioned within the housing. The hydraulic cylinder may also include a piston arranged on the piston end of the rod and configured to articulate within the housing. The hydraulic cylinder may also include a cap end secured to the housing and having a pocket for receiving a sensor. The pocket may have a cylindrical sidewall. The cap end may include a bore extending therethrough and arranged generally tangential to the sidewall where the bore extends into the cap end, breaches the sidewall, and extends further passed the pocket. The hydraulic cylinder may also include a retention pin configured for placement in the bore and for an interference fit with the sensor when the sensor is arranged in the pocket.

### TECHNICAL FIELD

The present application relates generally to hydraulic systems such as those used on work machines including excavators, trucks, or other heavy equipment for construction, farm implements, and other machines adapted for performing work. More particularly, the present application relates to a securing mechanism for a sensor on a hydraulic cylinder. Still more particularly, the present application relates to a side load retention pin for retaining a position sensor within a hydraulic cylinder.

### BACKGROUND

Position sensors may be arranged in hydraulic cylinders to monitor the position of the piston within the cylinder and, as such, allow for monitoring the extension and retraction of the piston rod extending out of a rod end of a hydraulic cylinder. These sensors may be secured in place using set screws that extend through the cap end of the hydraulic cylinder in an orientation generally perpendicular to an outer surface of the sensor. That is, the set screws may be arranged about a peripheral surface of the cap end of the hydraulic cylinder and may extend radially into and through a housing of the hydraulic cylinder to engage the outer surface sensor. Set screws can suffer from several different problems. In some cases the set screws simply do not get installed. In other cases, they are not torqued enough to maintain a tight grip on the sensor. In still other situations, and where a peripheral groove is provided, the set screw may fail to engage the groove because the sensor may not be fully in position when the set screw is placed.

U.S. Pat. No. 9,482,245 relates to a cylinder length sensor mounting/retaining assembly. The assembly includes a casing attachable to a blind end of the cylinder, a sensor retention cap affixable to the casing adjacent the blind end of the cylinder, and a locking pin extendable through the casing and positioned adjacent the sensor retention cap.

### SUMMARY

In one or more embodiments, a hydraulic cylinder may include a housing and a rod extending from a working end positioned outside the housing through a rod end of the housing to a piston end positioned within the housing. The hydraulic cylinder may also include a piston arranged on the piston end of the rod and configured to articulate within the housing. The hydraulic cylinder may also include a cap end secured to the housing and having a pocket for receiving a sensor. The pocket may have a cylindrical sidewall. The cap end may include a bore extending therethrough and arranged generally tangential to the sidewall where the bore extends into the cap end, breaches the sidewall, and extends further passed the pocket. The hydraulic cylinder may also include a retention pin configured for placement in the bore and for an interference fit with the sensor when the sensor is arranged in the pocket.

In one or more embodiments, a housing for a hydraulic cylinder may include a cap end comprising a pocket for receiving a sensor. The pocket may have a cylindrical sidewall. The cap end may have a bore extending therethrough and arranged generally tangential to the sidewall. The bore may extend into the cap end, breach the sidewall, and extend further passed the pocket.

In one or more embodiments, a retention pin may include a pinhead, a fastening portion distal to the pinhead and comprising a threaded engagement. The retention pin may also include a shaft portion distal to the fastening portion and configured for an interference fit with a retention groove on a sensor of a hydraulic cylinder. The retention pin may also include a positioning tip distal to the shaft portion and configured for free engagement with the retention groove.

### BRIEF DESCRIPTION OF THE DRAWINGS

FIG. 1 is a perspective partial breakaway view of a hydraulic cylinder having a sensor and a side load retention pin arranged therein, according to one or more embodiments.

FIG. 2 is a perspective view of a sensor, according to one or more embodiments.

FIG. 3 is a perspective view of the retention pin, according to one or more embodiments.

FIG. 4 is a distal end view of the retention pin and its engagement with a retention groove on a sensor, according to one or more embodiments.

FIG. 5 is a side view of the distal end of the retention pin and its engagement with the retention groove on a sensor, according to one or more embodiments.

FIG. 6 is a side view of the distal end of the retention pin and its engagement with the retention groove on a sensor, according to one or more embodiments.

FIG. 7 is a partial breakaway view of a bore for in the cap end of a cylinder for receiving the retention pin, according to one or more embodiments.

FIG. 8 is a block diagram depicting a method of assembling a hydraulic cylinder with a side load retention pin, according to one or more embodiments.

FIG. 9 is a perspective view of a cap end of a hydraulic cylinder with a retention pin engaged with a sensor allowing the threads to drive the pin into position.

FIG. 10 is a perspective view of a cap end of a hydraulic cylinder with a retention pin stopped short of engagement with a sensor preventing the threads from being used to drive the pin into position.

### DETAILED DESCRIPTION

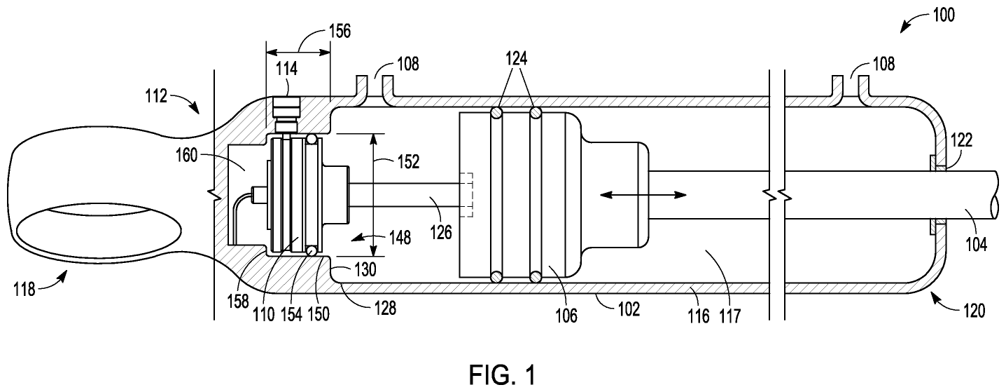

FIG. 1 is a perspective and partial breakaway view of a cap end 112 of a hydraulic cylinder 100. The hydraulic cylinder 100 may be configured to extend and retract and may be present on a work machine, for example. Work machines may include excavators, trucks with articulating truck beds, skid steers, or other work machines having hydraulic systems. The hydraulic cylinder 100 may be adapted, for example, to control the position of one or more articulating elements on the work machine.

With continued reference to FIG. 1, the hydraulic cylinder 100 may include a housing 102, a rod 104, a piston 106, and one or more ports 108 for delivering and/or receiving hydraulic fluid from the hydraulic cylinder 100. A sensor 110 may be arranged within the cap end 112 of the cylinder 100 and may be secured with a pin 114. It is to be appreciated that the location of the breakaway of FIG. 1 may not reveal the pin 114 if the breakaway is along the centerline of the cylinder 100. That is, as described in more detail herein, the pin 114 is offset from the centerline so as to tangentially engage the sensor. However, for purposes of general orientation of the parts, the pin 114 is shown in FIG. 1.

The housing 102 may be configured to contain and withstand relatively high fluid pressures and guide the piston 106 along a pathway allowing the piston 106 to articulate back and forth through a stroke length based on fluid flow on one more sides of the piston 106. The housing 102 may include a cylinder wall 116 defining a longitudinally extending cylindrical chamber 117. The housing 102 may also include a cap end 112 and a rod end 120. The cap end 112 may be a substantially closed end of the cylinder. A port 108 may be provided near the cap end for introduction and ejection of hydraulic fluid. The cap end 112 may include a cap eye 118 for securing the hydraulic cylinder 100 to the work machine. In one or more embodiments, the cap eye 118 may include an eye for receiving a pin or bolt allowing the hydraulic cylinder 100 to pivot relative to its connection to the work machine or implement of the work machine. The rod end 120 may close off of the end of the cylinder with respect to the piston 106 and the hydraulic fluid, but may include a sealed opening 122 for passing through of the rod 104. Like the cap end 112, a port 108 may be provided near the rod end 120 for introduction and ejection of hydraulic fluid.

The rod 104 may be secured to the piston 106 and may include a longitudinal element having a diameter smaller than the housing 102 and adapted for sleevably articulating within the housing 102 based on articulation of the piston 106. The rod 104 may be secured to the piston 106 at a piston end, may extend through the rod end 120 of the housing 102 to a working end, and may include an eye or other attachment feature on the working end. The eye or other attachment feature may allow the rod 104 to be secured to the work machine 100 or an implement of the work machine 100 and the eye may provide for pivoting motion of the connection by way of a pinned or bolted connection, for example.

The piston 106 may be arranged within the housing 102 and may be adapted to articulate through the housing 102 based on fluid flow into and out of the housing 102 on either side of the piston. In one or more embodiments, the piston 106 may be a cylindrical element having an outer diameter only slightly smaller than the inner diameter of the cylinder wall 116 of the housing 102. One or more seals 124 may be arranged on the piston 106 to provide the sealing engagement with the inner surface of the housing 102. The piston 106 may include a through bore for receiving and engaging the rod 104. For example, the piston 106 may threadably engage the rod 104 and, as such, may include a threaded through bore adapted to threadably secure the piston 106 to the rod 104.

Depending on the nature of the rod/piston connection and whether the rod extends fully through the piston, both the rod and the piston or just the rod may include a bore for receiving a sensing pipe 126 of the sensor 110. The bore may extend deep into the rod 104 in the form of a gun drilled bore. The bore may allow the piston 106 and the rod 104 to sleevably articulate over the sensing pipe 126.

The port or ports 108 of the hydraulic cylinder 100 may be adapted to deliver and receive hydraulic fluid from the hydraulic cylinder 100 and may be arranged at opposite ends of the housing 102 (i.e., one at the cap end 112 and one at the rod end 120). The ports 108 may provide for connection of hydraulic fluid lines and may provide the pathway for hydraulic fluid to enter and exit the hydraulic cylinder 100.

The cap end 112 of the cylinder 100 may be adapted for securing the cylinder 100 to the work machine or an implement thereof, containing cylinder pressure. As shown, the cap end 112 may include a bulkhead casting adapted for securing to the housing 102. As shown, the bulkhead casting may be welded to the cylinder wall 116 at a circumferentially extending weld 128. The bulkhead casting may include a piston stop surface 130.

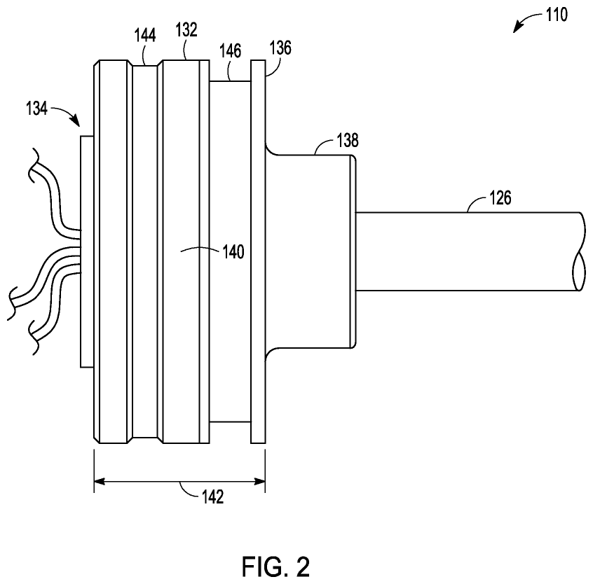

Referring to FIG. 2, the sensor 110 may include a puck-shaped housing 132 configured for arrangement in the cap end 112 of the hydraulic cylinder 100. The sensor 110 may also include a sensing pipe 126 extending from the puck-shaped housing 132 and into and along the length of the cylinder 100. The puck-shaped housing 132 may enclose and protect sensor elements that energize the sensing pipe 126 and/or receive information or signals from the sensing pipe 126 relating to the position of the piston 106 and/or the rod 104 along the sensing pipe 126. The puck-shaped housing 132 may include a substantially circular cap side 134 and a substantially circular cylinder side 136. The cylinder side 136 may have the sensing pipe 126 extending therefrom and a collar or other sensing pipe support or collar may be provided. The cap side 134 may include a wire port for passing wires or other communication lines out of the puck-shaped portion 132 of the sensor 110. The peripheral portion of the puck-shaped element 132 may include a substantially cylindrical outer wall 140 with a height 142. The outer wall 140 may include a retention groove 144 and a seal groove 146, each extending peripherally around the cylindrical outer wall 140 of the puck-shaped element 132. The seal groove 146 may be adapted to receive an O-ring, for example, and the retention groove 144 may be adapted for engagement by a retention pin 114. In one or more embodiments, the seal groove 146 may include a substantially rectangular cross-section and the retention groove 144 may include a trapezoidal shape with sloping sidewalls and a flat bottom where the groove 144 is wider at the surface of the outer wall 140 and narrower at the bottom of the groove 144.

As may be appreciated from a review of FIG. 1, the articulating motion of the piston 106 and rod 104 within the cylinder housing 102 may occur based on relatively high pressures acting on the piston 106. As such, maintaining the sensor 110 in a protected position and out of the way of the piston/rod motion may be helpful for the longevity of the sensor 110. To this end, the cap end 112 of the cylinder may be adapted for accommodating a sensor 110. That is, the cap end 112 may include a pocket 148 for receiving a sensor 110. As shown, the pocket 148 may include a substantially cylindrically shaped pocket with a cylindrical sidewall 150 for receiving the sensor 110. The pocket 148 may have a lateral width or diameter 152 adapted to receive the sensor 110 with limited tolerance around the sensor 110 such that an O-ring or other seal 154 on the sensor 110 may engage the sidewall 150 and create a seal between the piston/rod chamber 117 of the cylinder 100 and the back side of the sensor 110. The pocket 148 may have a depth for substantially fully seating the puck-shaped portion 132 of the sensor 110 in the pocket 148 to avoid contact with the articulating piston 106. That is, the longitudinal length 156 (e.g., in the direction of longitudinal articulation of the piston) of the sidewall 150 of the pocket 148 may be the same, similar, or slightly larger than the height 142 of the cylindrical outer wall 140 of the puck-shaped element 132. An annular surface or shoulder 158 may be provided at the bottom of the pocket 148 against which the sensor 110 may be seated. The annular surface or shoulder 158 may give way to a cavity 160 behind the pocket 148 for routing of wiring or communication lines from the sensor 110 through and out of the cap end 112 of the cylinder 100.

The sensor 110 may be retained in the pocket 148 with a retention pin 114. The retention pin 114 may extend through the cap end 112 of the cylinder 100 and may engage the retention groove 144 on the outer cylindrical wall 140 of the sensor 110 to retain the sensor 110 in position in the pocket 148. More particularly, the retention pin 114 may be arranged in a bore 162 that extends through the cap end 112 of the cylinder 100. The bore 162, and the pin 114 arranged therein, may be oriented substantially tangentially to the outer cylindrical wall 140 of the sensor 110 so that the side of the pin 114 engages the retention groove 144 of the sensor 110 in a cradling fashion. Moreover, various particular features of the bore 162, the bore position, the bore size, the pin size, and the pin geometry may provide for several installation and retention advantages.

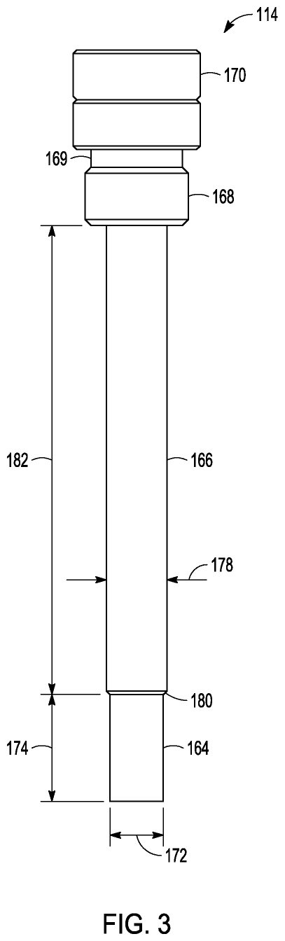

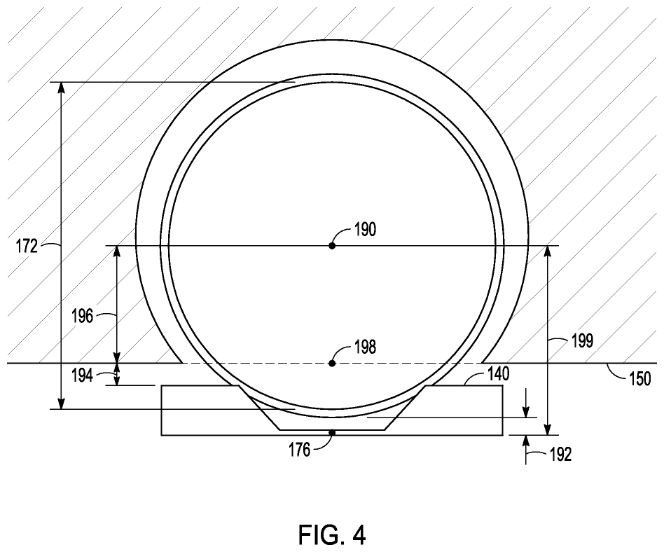

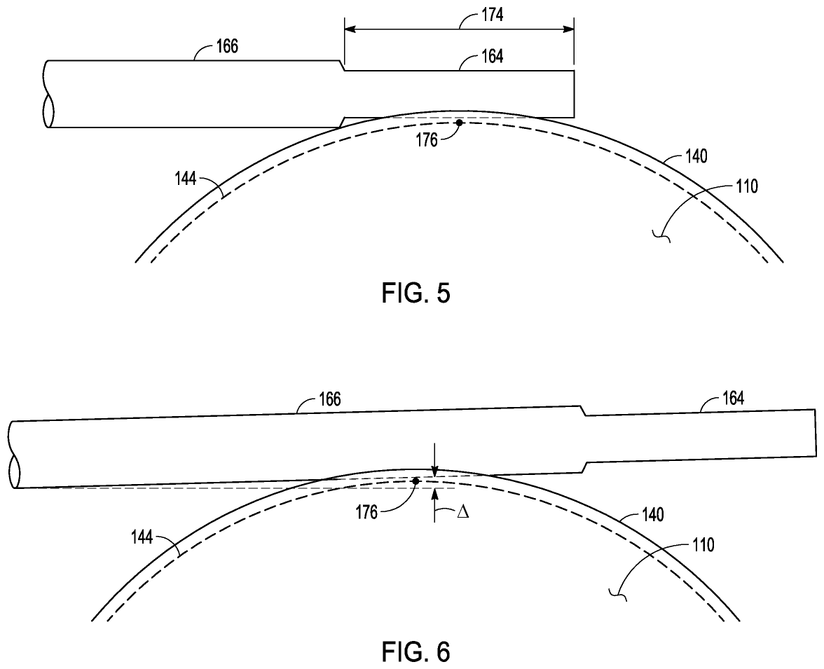

Beginning with the retention pin 114, and with reference to FIG. 3, the pin 114 may include a positioning tip 164, a shaft portion 166, a fastening portion 168, a seal groove 169, and a pinhead 170. The positioning tip 164 may be arranged at a distal most end of the retention pin 114. The positioning tip 164 may have a diameter 172 selected for allowing the positioning tip 164 to slip relatively freely into the retention groove 144 of the sensor 110 when the sensor 110 is fully seated in the pocket 148, or positioned against the shoulder 158 of the pocket 148, such that the retention groove 144 of the sensor 110 is aligned with the bore 162. That is, as shown in FIG. 4, the relationship of the center of the bore 162, the size of the bore 162, and the size of the positioning tip 164 may be selected to align the positioning tip 164 with the retention groove 144 and allow for generally resistance free motion of the positioning tip 164 into and/or across the groove 144 when the sensor 110 is fully seated. The positioning tip 164 may also be large enough that when the sensor 110 is not fully seated, the positioning tip 164 will not pass into the retention groove 144 and will, instead, contact the outside surface of the sensor housing 132. That is, as shown in FIG. 4, when the positioning tip 164 is in the groove 144, it may engage the sidewalls of the groove 144 in cradling fashion. That is, the diameter 172 of the positioning tip 164 may be large enough to avoid bottoming out in the groove 144 without also contacting both sidewalls of the groove 144. In one or more embodiments, the positioning tip 164 may include a diameter 172 ranging from approximately 6 mm to approximately 12 mm, or from approximately 7 mm to approximately 10 mm, or a diameter of approximately 8 mm may be provided. The positioning tip may have a length 174 selected to be long enough to provide a positioning function (e.g., reach into the retention groove 144) before the shaft portion 166 engages the sensor 110. That is, for example, as shown in FIG. 5, the length 174 of the positioning tip 164 may be selected to pass into the groove 144 and at least slightly passed the tangent point 176 before the shaft portion 166 with a wider diameter engages the edges of the retention groove 144. As such, given the tangential nature of the engagement, the positioning tip 164 may have a length 174 ranging from approximately 12 mm to approximately 30 mm or from approximately 16 mm to approximately 24 mm, or a length of approximately 20 mm may be provided.

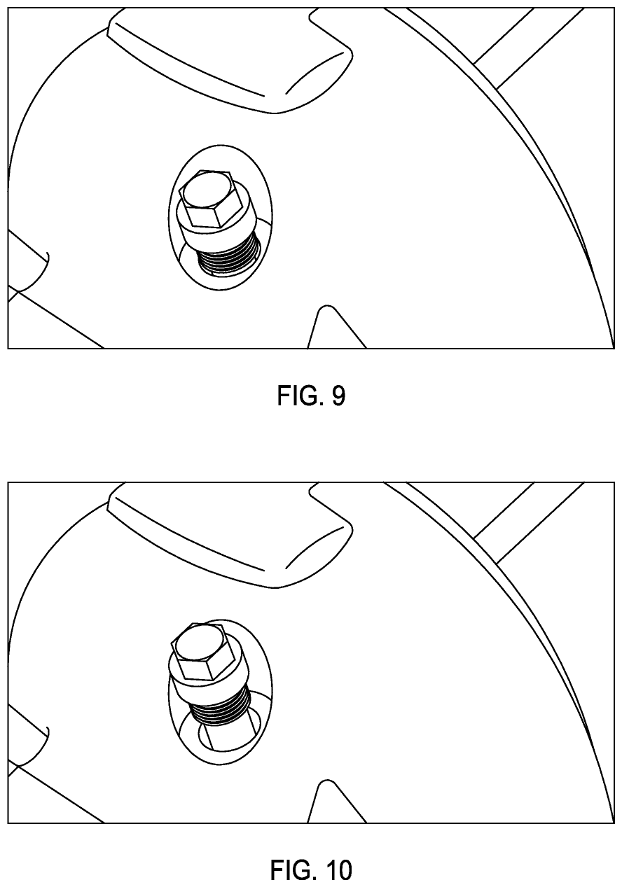

The shaft portion 166 of the retention pin 114 may be adapted to extend from a fastening portion 168 of the retention pin 114, through the bore 162, and across the side of the sensor 110 when the retention pin 114 is fully seated in the bore 162. In contrast to the positioning tip 164, the shaft portion 166 may be sized and positioned for an interference fit with the retention groove 144. That is, and with reference to FIG. 6, the relationship of the center of the bore 162, the size of the bore 162, and the size of the shaft portion 166 may be selected to cause the shaft portion 166 to deflect as it is forced across the tangent point 176 and engages the retention groove 144. Moreover, and as shown in FIG. 4, the diameter 178 of the shaft portion 166 may be selected to engage the sloping surfaces of the trapezoidal-shaped groove 144 without contacting the bottom of the groove 144 (e.g., a cradling engagement). That is, were a smaller diameter to be used, the shaft portion 166 may rest on the bottom of the groove 144 and may allow the sensor 110 to move longitudinally along the cylinder 100 and relative to the pin 114 before the pin 114 would engage the sloping walls of the groove 144. In one or more embodiments, the shaft portion 166 of the retention pin 114 may have a diameter 178 that is slightly larger than the positioning tip 164 to create the interference fit and a chamfered transition 180 between the positioning tip 164 and the shaft portion 166 may be provided. In one or more embodiments, the shaft portion 166 may have a diameter 178 ranging from approximately 6 mm to approximately 12 mm, or from approximately 7 mm to approximately 10 mm, or a diameter of approximately 8.5 mm may be provided. The shaft portion 166 may have a length 182 selected to allow engagement of threads on a fastening portion 168 of the retention pin 114 to engage threads on a corresponding fastening portion of the bore 162 when the positioning tip 164 is arranged in the retention groove 144 and the distal end of the shaft portion 166 has engaged a side of the sensor 110 as shown in FIG. 5. As shown in FIG. 9, this may allow the use of the threads to further drive the shaft portion 166 into its interference fit condition with the sensor 110 as shown in FIG. 6. However, and as mentioned, when the sensor 110 is not fully seated in the pocket 148, the positioning tip 164 may not pass into the retention groove 144 and the threads of the fastening portion 168 of the retention pin 114 may not engage the threads on a corresponding fastening portion of the bore 162 as shown in FIG. 10.

It is to be appreciated that while the shaft portion 166 may deflect to create an interference fit with the retention groove 144, the deflection may be limited to elastic deflection of the shaft portion 166. That is, the shaft portion 166 may deflect, but the relative positions and diameters mentioned may be selected to avoid stresses in the shaft portion that exceed the yield strength of the shaft portion material such that any deformations are temporary while the pin is in place and go away as the pin is removed. This may allow for the retention pin 114 to be smoothly removed from the bore 162 without hanging up on or getting caught on the sidewalls of the bore 162 due to more permanent deformations.

The fastening portion 168 of the retention pin 114 may include a threaded collar arranged proximal to the shaft portion 166. The threaded collar may be slightly larger than the shaft portion 166 or the same size as the shaft portion 166. In one or more embodiments, a larger collar may provide for better control over the alignment of the retention pin 114 with the bore 162 and stronger rotational strength for resisting the bending forces is the shaft portion 166. Moreover, in one or more embodiments, a larger threaded collar may provide an annular surface on a bottom side thereof that may receive an O-ring where tightening of the pin 114 causes the O-ring to engage an opposing annular surface and create a seal for the connection. In other embodiments, a seal groove 169 between the fastening portion 168 and the pin head 170 may be provided to receive an O-ring that engages a collar on the bore 162 an outboard side of the fastening portion 168. In one or more embodiments, for example, the connection may be a straight-thread O-ring (STOR) connection. While a threaded engagement between the fastening portions of the retention pin 114 and bore 162 has been described, a push fit connection, laterally extending pin, or other fastening mechanisms adapted to avoid motion of the pin 114 in a lateral direction (e.g., lateral to the cylinder 100 and longitudinal along the retention pin 114) may also be provided.

The pin head 170 may extend proximally from the fastening portion 168 and may be adapted for manipulating the retention pin 114 when the pin 114 is being inserted or removed from the bore 162. In one or more embodiments, the pin head 170 may include an internal or external tool engagement feature, such as an internal hex-shaped recess or an external hex-shaped outer surface. Still other tool engagement features may be provided such a square recess, square outer surface, star-shaped recess, straight slot, crossing slot, or other took engagement feature.

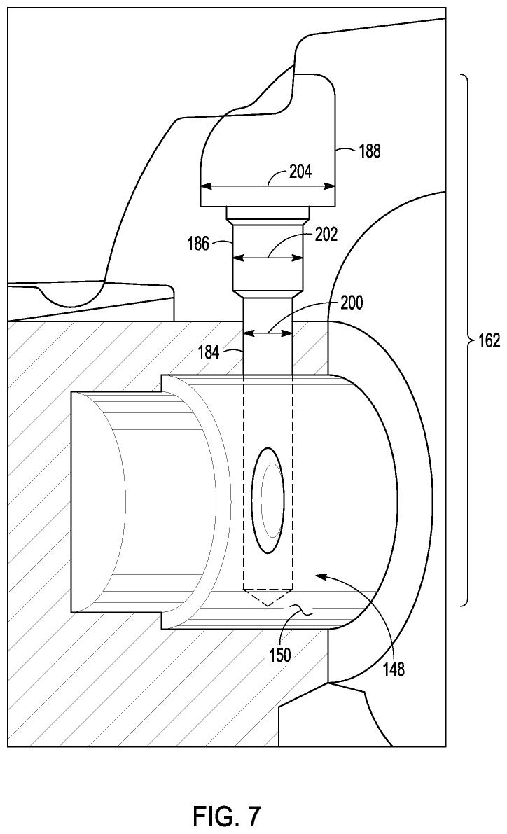

Turning now to the details of the bore 162 that the retention pin 114 may be inserted into. The bore 162 may extend through the cap end 112 of the cylinder 100 and may include a series of stages adapted for particular types of interfacing with the retention pin 114. As shown in FIG. 7, the bore 162 may include a sleeve portion 184, a fastening portion 186, and a pinhead counterbore 188.

The sleeve portion 184 may extend from a fastening portion 186 of the bore 162, further into the cap end 112 of the cylinder 100 toward the pocket 148. As mentioned, the bore 162 and, thus, the sleeve portion 184 thereof, may be arranged generally tangential to the cylindrical outer wall 140 of the sensor 110 and, as such, generally tangential to the sidewall 150 of the pocket 148. As shown in FIG. 7, the sleeve portion 184 may breach the sidewall 150 of the pocket exposing the retention pin 114 to the sensor 110 and may further extend beyond the pocket 148. More particularly, the centerline 190 of the sleeve portion 184 may have an offset distance 199 relative to a tangent point 176 on the sensor 110. For example, and with reference to FIG. 4, the centerline 190 of the sleeve portion 184 may be determined giving consideration to the gap 192 between the bottom of the retention groove 144 and the diameter 172 of the positioning tip 164 of the retention pin 114. Moreover, the tolerance or gap 194 between the cylindrical outer wall 140 of the sensor 110 and the sidewall 150 of the pocket 148 may be considered to determine the offset distance 196 of the sleeve portion centerline 190 from a tangent point 198 of the sidewall 150. In one more embodiments, for example, the centerline 190 of the bore 162 may be offset approximately 3.25 mm from a tangent point 198 of the sidewall 150 of the pocket 148 and approximately 4.5 mm from the bottom surface or tangent point 176 of the retention groove 144 on the sensor 110. Other particular offset distances 196/199 of the centerline 190 of the sleeve portion 184 of the bore 162 may be provided giving consideration to the size of the positioning tip 164 of the retention pin 114, the cradled relationship of the positioning tip 164 in the retention groove 144 and the gap 194 between the sensor 110 and the sidewall 150 of the pocket 148.

The sleeve portion 184 may be adapted to receive the positioning tip 164 and the shaft portion 166 of the retention pin 114. As such, the sleeve portion 184 may have a diameter or other crossing dimension 200 larger than the diameter or other crossing dimension 178 of the shaft portion 166 of the retention pin 114 and large enough to allow a particular amount of lateral deflection of the shaft portion 166 of the retention pin 114. That is, as mentioned above, the interference fit of the shaft portion 166 with the sensor 110 may cause the shaft portion 166 to deflect slightly as it engages the sensor 110. The sleeve portion 184 of the bore 162 may have a diameter or other crossing dimension 200 that is large enough to accommodate this deflection. However, the diameter or other crossing dimension 200 of the sleeve portion 184 may also be selected to limit the deflection of the retention pin 114 such that the pin 114 is unable to move fully out of the retention groove 144 due to contact with an opposing wall of the sleeve portion 184. In this way dislodgement of the sensor 110 may be avoided. In one or more embodiments, the sleeve portion 184 may have a diameter ranging from approximately 6.5 mm to approximately 12.5 mm, or from approximately 7.5 mm to approximately 10.5 mm, or a diameter of approximately 9 mm may be provided.

The fastening portion 186 of the bore 162 may be configured for engagement by the fastening portion 168 of the retention pin 114 and may provide for seated engagement of the fastening portion 168 of the retention pin 114. In one or more embodiments, as shown, the fastening portion 186 may include a bore having a larger diameter or crossing dimension 202 than the sleeve portion 184 and providing an annular seat at a top of the sleeve portion 184. This annular seat may be adapted for engagement by an O-ring on a bottom of an opposing annular surface of the retention pin 114. In other embodiments, the fastening portion 186 may have a collar on an outboard side thereof that is adapted for engagement of an O-ring arranged between the fastening portion 168 and the pinhead 170 of the retention pin 114. The peripheral wall of the fastening portion 186 of the bore 162 may include a threaded surface for engagement with threads on the retention pin 114 and the fastening portion 186 may have a depth sufficient to accommodate the fastening portion 168 of the retention pin 114. It is to be appreciated that where fastening mechanisms other than threads are provided on the retention pin 114, alternative shapes and features may be provided on the fastening portion 186 of the bore 162 that correspond to those features.

The pinhead counterbore 188 may include yet a larger portion of the bore having a diameter or other crossing dimension 204 larger than fastening portion 186. The diameter or crossing dimension 188 of the pinhead counterbore 188 may be selected based on the type of retention pin head 170 that is provided. For example, where an external tool engagement feature is provided on the retention pin 114, a wider counterbore 188 may be provide to allow sockets or wrenches to access the outer surface of the pinhead 170. Where internal or recessed tool engagement features are provided on the retention pin 114, a smaller or narrower counterbore 188 may be provided.

### INDUSTRIAL APPLICABILITY

In operation and use, the present side load retention pin system may provide for retaining sensors within the hydraulic cylinder. The prominent nature of the retention pin may make the pin unlikely to be omitted like set screws. Moreover, the interference fit of the retention pin and the sealing type fastening port may help avoid insufficiently tight retention systems. Finally, the positioning tip of the retention pin may help to make sure the sensor is fully seated in the pocket before the retention pin is advance into position.

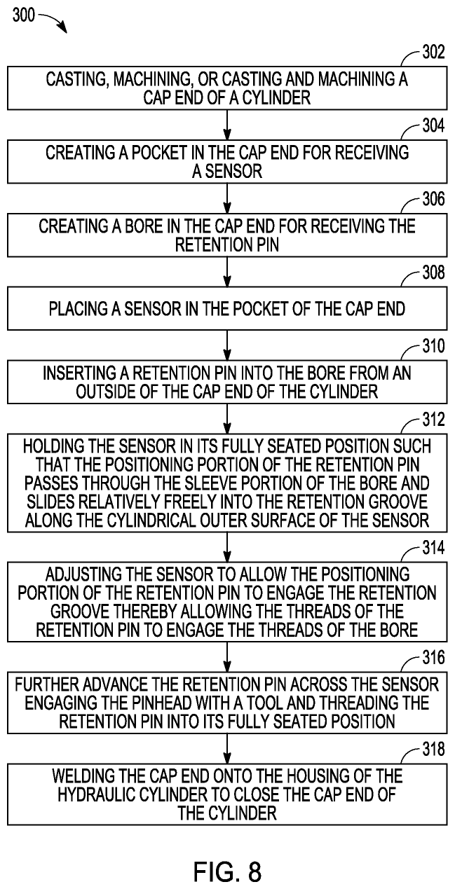

In one of more embodiments, a method 300 of assembling a cap end of a hydraulic cylinder may be provided as shown in FIG. 8. In one or more embodiments, the method may include casting, machining, or casting and machining a cap end of a cylinder 302. The casting or machining may include creating a pocket in the cap end for receiving a sensor 304 and creating a bore in the cap end for receiving the retention pin 306. The various feature of the pocket and the bore mentioned above may be incorporated into these elements. The method may also include placing a sensor in the pocket of the cap end 308 such that the sensor is seated against the annular surface or shoulder on a bottom of the pocket. The method may also include inserting a retention pin into the bore from an outside of the cap end of the cylinder 310. The sensor may be held in its fully seated position such that the positioning tip of the retention pin passes through the sleeve portion of the bore and slides relatively freely into the retention groove along the cylindrical outer surface of the sensor 312. Where the sensor has become unseated, the positioning tip of the retention pin may engage the cylindrical outer wall of the sensor and the threads on the retention pin may stop short of engaging the threads on the fastening portion of the bore, thereby preventing further forced advancement of the retention pin. Adjustment of the sensor may be performed to allow the positioning tip of the retention pin engage the retention groove thereby allowing the threads of the retention pin to engage the threads of the bore 314. The retention pin may be further advanced across the sensor by engaging the pinhead with a tool and threading the retention pin into its fully seated position where the O-ring seal on the fastener engages the port on the bore and creates a seal 316. The advancing of the retention pin may cause engagement of the retention groove by the shaft portion of the retention pin. The shaft portion may engage the sensor in an interference fit and may deflect laterally thereby applying a normal force on the retention groove of the sensor at the tangent point. The shaft portion may engage the retention groove in a cradling fashion, engaging the sloping walls of the retention groove without engaging the bottom of the groove and, as such, preventing or resisting longitudinal movement of the sensor in two directions. The cap end of the cylinder may be welded onto the housing of the hydraulic cylinder to close the cap end of the cylinder 318.

The above detailed description is intended to be illustrative, and not restrictive. The scope of the disclosure should, therefore, be determined with references to the appended claims, along with the full scope of equivalents to which such claims are entitled.

1. A hydraulic cylinder, comprising:
a housing;
a rod extending from a working end positioned outside the housing through a rod end of the housing to a piston end positioned within the housing; and
a piston arranged on the piston end of the rod and configured to articulate within the housing;
a cap end secured to the housing and comprising a pocket for receiving a sensor, the pocket having a cylindrical sidewall, the cap end having a bore extending therethrough and arranged generally tangential to the sidewall where the bore extends into the cap end, breaches the sidewall, and extends further passed the pocket; and
a retention pin configured for placement in the bore and for an interference fit with the sensor when the sensor is arranged in the pocket,
wherein the sensor comprises a retention groove and the interference fit comprises deflection of the retention pin when the retention pin is seated in the retention groove.

2. The cylinder of claim 1, wherein the retention pin further comprises a positioning tip.

3. The cylinder of claim 2, wherein:
the sensor comprises a retention groove arranged adjacent the cylindrical sidewall of the pocket when the sensor is placed in the pocket;
the groove defines a tangent point;
a centerline of the bore is offset from the tangent point of the retention groove; and
the positioning tip is sized to freely engage the retention groove when the sensor is fully seated in the pocket.

4. The cylinder of claim 3, wherein the positioning tip is prevented from engaging the retention groove when the sensor is not fully seated in the pocket.

5. The cylinder of claim 4, wherein the retention pin comprises a fastening portion and when the positioning tip is prevented from engaging the retention groove, the fastening portion is not engaged with the bore and when the positioning tip engages the retention groove, the fastening portion engages the bore to drive the retention pin across the retention groove and compress a seal.

6. (canceled)

7. The cylinder of claim 1, wherein the deflection comprises an elastic deflection of the retention pin.

8. The cylinder of claim 1, wherein the retention pin comprises a positioning tip with a first diameter and a shaft portion arranged proximal to the positioning tip and having a second diameter slightly larger than the first diameter.

9. The cylinder of claim 8, wherein the first diameter and the second diameter are each adapted for a cradling engagement with a retention groove on the sensor.

10. The cylinder of claim 1, wherein the pocket has a depth defined by a length of the sidewall, the length being configured for fully receiving the sensor.

11. A housing for a hydraulic cylinder, comprising:
a cap end comprising a pocket for receiving a sensor, the pocket having a cylindrical sidewall, the cap end having a bore extending therethrough, for receiving a retention pin, and being arranged generally tangential to the sidewall where the bore extends into the cap end, breaches the sidewall, and extends further passed the pocket,
wherein:
the sensor comprises a retention groove that is arranged adjacent the cylindrical sidewall of the pocket when placed therein, the retention groove defining a tangent point;
a centerline of the bore is offset from the tangent point of the retention groove; and
a positioning tip of the retention pin freely engages the retention groove when the sensor is fully seated in the pocket.

12-13. (canceled)

14. The housing of claim 11, wherein the positioning tip is prevented from engaging the retention groove when the sensor is not fully seated in the pocket.

15. The housing of claim 14, wherein the retention pin comprises a fastening portion and when the positioning tip is prevented from engaging the retention groove, the fastening portion is not engaged with the bore.

16. The housing of claim 11, wherein the sensor comprises a retention groove and the interference fit comprises deflection of the retention pin when it is engaged with the retention groove.

17. A retention pin for retaining a sensor in a hydraulic cylinder, the retention pin comprising:
a pinhead;
a fastening portion distal to the pinhead and comprising a threaded engagement;
a shaft portion distal to the fastening portion and configured for an interference fit with a retention groove on the sensor of the hydraulic cylinder; and
a positioning tip distal to the shaft portion, configured for free engagement with the retention groove, and having a length adapted to engage the retention groove when the shaft portion is engaged with an outer cylindrical surface of the sensor.

18. The retention pin of claim 17, wherein the positioning tip has a first diameter and the shaft portion has a second diameter slightly larger than the first diameter.

19. (canceled)

20. The retention pin of claim 17, wherein the positioning tip and the shaft portion are sized for a cradling engagement with the retention groove.
